(19) United States
(12) Patent Application Publication
(10) Pub. No.: US 2002/0075334 A1
(43) Pub. Date: Jun. 20, 2002

(54) Hand gestures and hand motion for replacing computer mouse events

(76) Inventor: Evangelos A. Yfantis, Las Vegas, NV (US)

Correspondence Address: Weide & Associates, Ltd, 11th Floor, Suite 1130, 330 S. 3rd Street, Las Vegas, NV, 89101, US

(21) Appl. No.: 09/972,433

(22) Filed: Oct. 5, 2001

Related U.S. Application Data
(60) Provisional application No. 60/238,799, filed on Oct. 6, 2000.

(51) Int. Cl. G09G 5/00

(52) U.S. Cl. 345/863

(57) ABSTRACT

The invention is a method and apparatus for utilizing a user's gestures, such as hand gestures, as input to a computing device. In one embodiment, the method and apparatus effectuate input in the form of hand-gestures detected by a camera. The apparatus includes a computing device, a camera and software for recognizing the hand-gestures. Computer actions are initiated in response to detected user gestures. In one embodiment, the computer actions are events similar to that of the mouse, such as changing the position of a selector or cursor or changing other graphical information displayed to the user.

### FIELD OF THE INVENTION

The present invention relates to input devices and methods of providing input to a computer or similar device.

### BACKGROUND OF THE INVENTION

A variety of input devices having various limitations are known for providing input to a computer or similar device. For example, the computer mouse has been used successfully to open up windows, scroll, point to perform interactive computer graphics and other events. The mouse is connected to the computer via a cable, or wireless, to the computer.

Cameras are also well known, and in the past have been used to provide data input to a computer for such applications as video telephony, teleconferencing, and the like.

### SUMMARY OF THE INVENTION

The invention comprises a method and apparatus for providing input to a computing device. Preferably, input to the computing device comprises a camera connected to the computing device.

In one embodiment, the apparatus includes a computing device including a processor and a memory, a camera or other image collection device connected to the computing device, and computer software executable by the computing device for implementing a method of the invention.

In one embodiment of a method of the invention, a user of a computing device performs unique and characteristic hand or other body-implemented gestures to initiate events similar to those of the mouse. The unique hand gesture is recorded or collected by the camera and transmitted to the computing device, such as to the computer memory. Software residing at the computer is utilized to compare the user-gesture to user-gesture information stored at the computer. If the user-gesture comprises one of the predetermined or predefined user-gestures, then a computer action is implemented.

In one embodiment, the computer actions are similar to actions which may be implemented using a mouse or similar input device. For example, the computer actions may comprise the movement of a selector (or cursor) or other manipulation of graphical information displayed to the user on a display of the computing device.

In one embodiment, before the computer begins implementing computer actions in response to user-gestures, the user must perform a particular initiating user-gesture. Once the initiating user-gesture is detected, actions associated with later detected user-gestures are performed.

Further objects, features, and advantages of the present invention over the prior art will become apparent from the detailed description of the drawings which follows, when considered with the attached figures.

### DESCRIPTION OF THE DRAWINGS

FIG. 1 is a perspective view of one embodiment of an apparatus of the invention comprising a computing device and a camera for capturing user-gestures; and

FIG. 2 illustrates a configuration of the computing device illustrated in FIG. 1, the computing device including a processor and a memory.

### DETAILED DESCRIPTION OF THE INVENTION

The invention is a method and apparatus for providing input to a computing device. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

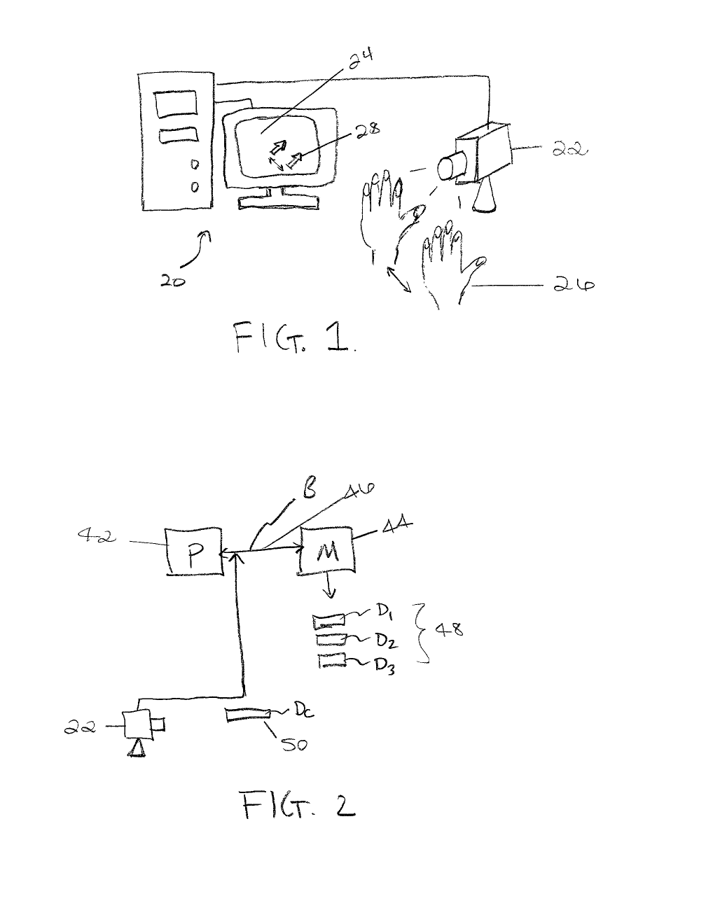

Referring to FIGS. 1 and 2, a preferred embodiment of an apparatus of the invention comprises a computer or computing device 20 having a camera 22 connected to it. The computer 20 may have a wide variety of configurations. In one embodiment, the computing device 20 includes a processor or processing device 42 for executing computer readable program code or “software.” The computing device 20 also preferably includes a memory 44 for storing information or data. In one embodiment, the computing device 20 includes a display 24 for displaying graphical information, such as a graphical user interface. This graphical information may include a selector or cursor 28, as is known.

The computing device 20 may include a wide variety of other devices and components. For example, the processor 42 and memory 44 may be coupled by a system bus 46.

The camera 22 may comprise any of a wide variety of image collection devices. The camera 22 preferably provides a data output 50 to the computer 20. The data output 50 may be provided by a wide variety of connections, such as parallel, serial, USB, Firewire™ and other communication protocols/architectures. In one embodiment, the data is output 50 from the camera 22 to the computer 20 via the system bus 46.

The computer 20 is provided with computer readable program code or “software” for implementing one or more methods of the invention. In one embodiment, the software is arranged to determine if a user-gesture is one of a particular set of user-gestures, and if so, to perform a computer action.

In a preferred embodiment, the computer action comprises changing or manipulating the graphical information displayed to the user. For example, the computer action may comprise movement of the position of the displayed selector or cursor, selection of displayed information or change of the displayed information. In one embodiment, the computer actions are similar to those which may be implemented by input to a computer mouse or similar input device.

In accordance with a method, a user 26 performs a unique and characteristic hand gesture to initiate events similar to those of the mouse. This unique hand gesture is recorded by the camera 22, inputted to the computer memory 44, and is recognized by software which resides in the computer as an initiation of events similar to the ones of the mouse.

In one embodiment, information 48 representing one or more user-gestures, such as hand gestures, is stored at the computing device 20 such as in the memory 44. In one embodiment, this information 48 comprises a plurality of data sets representing individual gestures. Information representing the image of a collected user-gesture from the camera 22 or other image collection device is compared to the stored information 48 of user-gestures. In one embodiment, the collected information comprises a data set 48. If the information representing the user's 26 gesture as detected by the camera 22 matches the information representing one of the particular stored 48 hand-gestures, then a computer action is initiated. The computer action may be initiated using information associated with the particular matching user-gesture.

In accordance with the invention, the user 26 can move the hand cursor (the hand cursor replaces the mouse cursor), by pointing to a screen location, and then dragging his or her finger to a desired location of the screen. The user 26 can activate a button by pointing his/her finger towards the button. The user can associate a different event to each one of his fingers, or to the combination of fingers. In accordance with one embodiment of the invention, the user 26 may draw on the screen by moving one or more fingers, pop up menus, by moving one or more fingers, terminate, or initiate processes by pointing in a button, and in general assign more functions to the finger and hand-gestures than is permitted by the mouse, or track ball, or similar schemes.

The camera 22 or other image collection device may be embedded in the frame of the monitor facing the user, or be of the type which can be moved freely so that a view of the user must be available.

In one embodiment, the method includes the step of determining if the user 26 has performed a particular initiating hand-gesture. If the initiated hand gesture is made then the software is arranged to cause an interrogation of the hand gesture events that follow to decide what events are to activated. Those events could be pop-up menus, dragging of the cursor, initiating or terminating processes by using appropriate hand gestures. If the initiated gesture is not performed, then the computing device 20 may be arranged to ignore other inputted hand-gesture information. This prevents, for example, a passer-by or non-authorized user's gestures from being accepted by the computing device.

Software is provided which causes a polling of the camera input to decide if a respecified hand gesture motion which signifies the start of hand-gesture events has taken place.

One embodiment of the invention comprises a method, implemented as a software algorithm, which consists of a recognition routine, which understands if any of the hands are in camera view or not. Of course, the software may also be implemented as hardware, such as a chip configured to accomplish the same sequence of steps.

The user-gestures which may be accepted may vary. In one embodiment, the user-gestures include hand-gestures. For example, if one or more hands are in camera view, the software may be adapted to recognize the fingers, and detect the relative position of the fingers.

By performing texture analysis, as well as finger motion analysis, the computer 20 can decide if the hand gestures have any special meaning or not. If the hand(s) gesture(s) are meaningful then the software may perform semantic analysis to decide what the meaning of the hand gesture(s) are and what should be the action to be taken.

The hand gesture events may be terminated by a unique hand gesture(s) which is associated with the termination of the hand gesture events. The hand gesture event can be renewed by performing the unique hand gesture which specifies initiation of the hand gesture events. In another embodiment, acceptance of hand or user-gesture information may be terminated upon non-detection of user-gesture input for a period of time.

It will be understood that the above described arrangements of apparatus and the method therefrom are merely illustrative of applications of the principles of this invention and many other embodiments and modifications may be made without departing from the spirit and scope of the invention as defined in the claims.

I claim:

1. A method of providing input to a computing device comprising:
accepting user-gesture image information from a user of the computing device;
determining if the user-gesture image information comprises an initiation gesture, and if so, evaluating accepted user-gesture image information thereafter, said step of evaluating comprising comparing said accepted user-gesture image information to predetermined user-gestures associated with one or more computer implemented actions; and
implementing said one or more actions if accepted user-gesture image information matches a predetermined user-gesture.

2. The method in accordance with claim 1 wherein said step of accepting comprises capturing user-gesture information with an image collection device.

3. The method in accordance with claim 1 wherein said computing device includes a display displaying graphical user information and said computer implemented actions comprise manipulation of said graphical user information.

4. The method in accordance with claim 3 wherein said display displays a selector and said computer implement action comprises changing the displayed position of said selector on said display.

5. The method in accordance with claim 1 wherein said user-gesture comprises a hand movement.

6. The method in accordance with claim 1 wherein said step of determining if said user-gesture comprises an initiation gesture comprises comparing said accepted user-gesture information to user-gesture information comprising an initiating user-gesture stored at said computing device

7. A computing device comprising:
a processor;
a memory coupled to said processor;
an image collection device adapted to provide collected user-gesture information to said processor;
information stored in said memory defining a set of user-gestures and at least one computer action associated with each user-gesture; and
computer executable program code stored in said memory and executable by said processor, said computer executable program code adapted to compare collected user-gesture information to said information stored in said memory and for executing said computer action for each collected user-gesture matching one of said user-gestures of said set of user-gestures defined by said information stored in said memory.

8. The computing device in accordance with claim 7 wherein said set of user-gestures includes at least one initiating gesture.

9. The computing device in accordance with claim 7 wherein said set of user-gestures includes one or more user hand-gestures.

10. A method of providing input to a computing device comprising:
detecting a user-gesture using an image collection device;
configuring said computing device to accept user-gesture input if said detected user gesture comprises a particular initiating gesture;
detecting additional user-gestures; and
initiating computer actions in response to said additional detected user-gestures matching particular user-gestures.

11. The method in accordance with claim 10 wherein said user-gestures comprise hand gestures.

12. The method in accordance with claim 10 wherein said image collection device comprises a camera.

13. The method in accordance with claim 10 including the step of comparing information representing said detected user-gesture to information representing an initiating user-gesture.

14. The method in accordance with claim 10 including the step of configuring said computing device to cease accepting user-gesture input if a particular stopping user-gesture is detected.
